(19) United States
(12) Patent Application Publication
(10) Pub. No.: US 2010/0196867 A1
(43) Pub. Date: Aug. 5, 2010

(54) PHANTOM FOR ULTRASOUND GUIDED NEEDLE INSERTION AND METHOD FOR MAKING THE PHANTOM

(75) Inventors: Marion Geerligs, Eindhoven (NL); Sieglinde Neerken, Eindhoven (NL); Robert Alfred Bezemer, Alphen Aan Den Rijn (NL); Robertus Hekkenberg, Oude Wetering (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/668,075

(22) PCT Filed: Jul. 8, 2008
(86) PCT No.: PCT/IB2008/052741

§ 371 Date: Jan. 7, 2010

(30) Foreign Application Priority Data
Jul. 13, 2007 (EP) 07301233.8

(51) Int. Cl. G09B 23/30

(52) U.S. Cl. 434/272

(57) ABSTRACT

The invention relates to a phantom for simulating the ultrasound guided insertion of a needle in a blood vessel of a human body site. The phantom comprises: a skin mimicking layer (2), formed in a first material; —a tissue mimicking layer (3), formed in a second material and at least one artificial blood vessel (4a, 4b, 4c), formed in a third material, the first, second and third material being arranged to reproduce both the mechanical and the ultrasound properties of the corresponding parts of the human body site. Thanks to the invention, the phantom permits a realistic simulation of a human body site behavior.

### FIELD OF THE INVENTION

The invention relates to needle insertion and more particularly to ultrasound guided insertion.

### BACKGROUND OF THE INVENTION

Insertion of a needle into a blood vessel of a patient is a very common medical procedure in order, for instance, to gather blood from the vessel or to inject a product such as a vaccine. The insertion of the needle may not always be performed perfectly and monitoring of the insertion may be beneficial. Consequently, there was a great need for ultrasound guided needle insertion.

Ultrasound guided needle insertion may be performed manually or automatically. In the case of manual insertion, a person may hold ultrasound imaging means—such as an ultrasound probe—in one hand and a syringe holding the needle in the other hand; as the needle is inserted, the person can check the movements of the needle in the tissues of the patient on images obtained in real-time thanks to the imaging means. In the case of automated insertion, a device for the automated needle insertion is provided, comprising driving means for inserting the needle, ultrasound imaging means and image processing means, which analyze the images of the needle in the skin taken by the imaging means; the information from the processing means is used for controlling the driving means.

An ultrasound guided needle insertion process should be tested prior to its performing on a human body, as can be easily understood; in particular, this testing may be performed for development, evaluation, optimization, certification, pre-treatment planning or medical staff training purposes, whether for manual or automated insertion. Tests may be performed on a test object, which is usually designated as a phantom or manikin. The phantom is an object that simulates a specific human body site and into which the needle is inserted as if it were in a real human body site, for testing the needle insertion process.

The phantom should be designed to simulate the behavior of the human body site during the needle insertion. US 2005/0202381 discloses an anthropomorphic phantom made of a moldable, elastomeric tissue-simulating chemical composition. Scattering agents and pigments may be added to provide a phantom that simulates the sonographic characteristics of living tissue. The phantom body may contain empty or liquid filled cavities and conduits that simulate internal structures. The internal cavities and structures are formed by placing a removable secondary mold inside the primary mold. For instance, hollow rods may be disposed longitudinally inside the primary mold and then removed, thereby forming a hollow conduit simulating veins or arteries.

The phantom of US 2005/0202381 permits to adjust the sonographic characteristics of the phantom to more closely mimic human tissue. However, it does not permit to mimic the behavior of a human body site when a needle is inserted in a blood vessel. Indeed, veins exhibit an exceptional deformation behavior due to needle insertion: they collapse easily and smaller veins may also be pushed aside; as a result, the desired blood vessel might not be hit in a single insertion.

### SUMMARY OF THE INVENTION

It is therefore an object of the present invention to provide a phantom for testing an ultrasound guided needle insertion method and that mimics the behavior of a human body site when a needle is inserted in a blood vessel.

In accordance with the present invention there is provided a phantom for simulating the ultrasound guided insertion of a needle in a blood vessel of a human body site, the phantom comprising:

a skin mimicking layer formed in a first material;

a tissue mimicking layer, formed in a second material and

at least one artificial blood vessel, formed in a third material,

the first, second and third material being arranged to reproduce both the mechanical and the ultrasound properties of the corresponding parts of the human body site.

Thanks to the invention, the phantom permits a realistic simulation of the human body behavior during an ultrasound guided needle insertion in a blood vessel, since the phantom comprises a particular material for mimicking each particular part of the human body site, the materials being arranged to reproduce the mechanical as well as the ultrasound properties of the corresponding (mimicked) parts of an actual human body. Therefore, the phantom mechanically behaves as a human body and permits a realistic ultrasound imaging of the needle insertion. In other words, the phantom of the invention enables to simulate the anatomy of a specific human body site, the deformation behavior of the blood vessels and their surroundings and the ultrasound properties of the blood vessels, tissues and skin when inserting a needle into a blood vessel. The phantom is adapted for simulating a manual as well as an automated needle insertion method.

According to an embodiment, the artificial blood vessel comprises a tubular wall which is formed in the third material.

According to an embodiment, the second and third materials are different.

According to an embodiment, the first and third materials are similar or identical.

According to an embodiment, the first and third materials are latex, in particular fluid latex.

According to an embodiment, the second material is an aqueous gel, in particular a gel substantially comprising between 1% w/v and 1.5% w/v of agarose, with 0.88% w/v of an Al₂O₃ powder with particles of a 0.3 μm diameter, 0.94% w/v of an Al₂O₃ powder with particles of a 3.0 μm diameter, 0.54% w/v of SiC and 0.43% of BC, in pure water.

According to an embodiment, the second material is an alginate based hydrogel.

According to the invention there is also provided a process for making the phantom presented above, comprising:

preparing a skin mimicking layer,

preparing a mixture for forming a tissue mimicking layer,

preparing at least one artificial blood vessel,

disposing the artificial blood vessel in a mold comprising means for holding the artificial blood vessel,

pouring the mixture around the artificial blood vessel for forming the tissue mimicking layer and

depositing the skin mimicking layer on the tissue mimicking layer.

These and other aspects of the invention will be more apparent from the following description with reference to the attached drawings.

### BRIEF DESCRIPTION OF THE DRAWINGS

FIG. 1 is a perspective schematic view of a phantom according to an embodiment of the invention and

FIG. 2 is a sectional schematic side view of the phantom of FIG. 1.

### DETAILED DESCRIPTION OF THE EMBODIMENTS

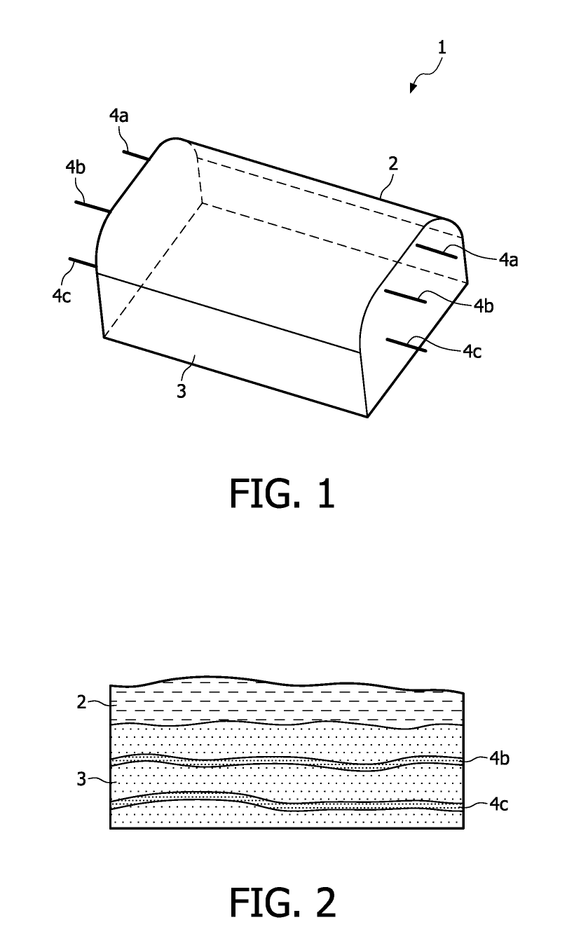

With reference to FIGS. 1 and 2, a phantom 1 according to the invention comprises a skin mimicking layer 2, a tissue mimicking layer 3 and artificial blood vessels 4a, 4b, 4c. The phantom 1 is a test object that is used in simulation of ultrasound image-guided medical invasive procedures, namely insertion of a needle in a blood vessel of a human body site. In the embodiment described, the phantom 1 mimics the elbow inner region of a human body with its superficial veins, where venipuncture is usually performed. The invention in particular applies to venipuncture, but it more generally applies to any insertion of a needle into a blood vessel of a human body site.

The skin mimicking layer 2 is formed in a first material, which in this embodiment is latex, in particular fluid latex; the thickness of the skin mimicking layer 2 is substantially equal to the one of skin in the elbow region of a human body. The tissue mimicking layer 3 here mimics a fat layer and is formed in a second material, which in this embodiment is an aqueous gel (or hydrogel); the tissue mimicking layer 3 further comprises an attenuation powder for adjusting its ultrasound properties. Each artificial blood vessel 4a, 4b, 4c is formed by a flexible tubular member, comprising a tubular wall; the walls of the artificial blood vessels 4a, 4b, 4c are formed in a material that, in the described embodiment, is the same as the material forming the skin mimicking layer 2, namely fluid latex; indeed, in the elbow region, the walls of the blood vessels exhibit similar mechanical and ultrasound properties as the skin layer.

By the expression “formed in” a particular material, it should be understood that the corresponding part mainly comprises this material, which is its main component, but that it may comprise other materials or components. For instance, the tissue mimicking layer 3 is formed in a hydrogel but further comprises an attenuation powder.

The phantom 1 of the invention is adapted to reproduce the mechanical properties as well as the ultrasound properties of the human body site it mimics. By reproducing the mechanical properties, it should be understood that it reproduces the mechanical behavior of a body site (skin, fat layer and blood vessels) when a needle is inserted in a blood vessel. In particular, it should simulate the exceptional deformation behavior of a blood vessel during the insertion of a needle, notably the collapsibility and/or rolling away (the fact of being pushed aside) of a blood vessel and its surroundings. Besides, the phantom 1 of the invention permits the insertion of a needle several times into the phantom 1, since the material of the phantom 1 recovers its initial shape after an insertion; moreover, the phantom 1 may be stored and re-used.

The phantom 1 also reproduces the ultrasound properties of the human body site it mimics; by ultrasound properties, it should notably be understood the attenuation and speed of sound within the material. The ultrasound properties are of relevance because information obtained from ultrasound images, such as the size and depth of the target blood vessel as well as the real-time monitoring of the needle insertion, are used to perform the needle insertion; ultrasound provides insight into the deformation behavior of the blood vessels and can therefore help to guide the needle into the target blood vessel.

As the mechanical as well as the ultrasound properties are reproduced, a needle insertion in the phantom 1 of the invention simulates well a needle insertion in an actual human body site.

Again, since it reproduces the mechanical and ultrasound properties of a human body site, the phantom 1 of the invention reproduces, in combination, anatomy, mechanical and geometrical deformation behavior and ultrasound properties of a human body site within a single phantom. In brief, the phantom 1 of the invention is a two-layer model, with a skin layer 2 and a fat layer 3, with collapsible blood vessels 4a, 4b, 4c embedded in the fat layer 3. In order to reproduce the mechanical as well as ultrasound properties of a human body site, the phantom 1 of the invention comprises different elements formed in different materials, as in an actual human body site, those materials reproducing the mechanical and ultrasound properties of the corresponding parts of a human body site: the skin mimicking layer 2 reproduces the mechanical and ultrasound properties of skin, the tissue mimicking layer reproduces the mechanical and ultrasound properties of tissue (namely fat), the artificial blood vessels 4a, 4b, 4c reproduce the mechanical properties of blood vessels. The elements of the human body site are mimicked by distinct (or discrete) parts of the phantom 1: the artificial blood vessels 4a, 4b, 4c form elements distinct from the fat mimicking layer 3, that in turn is distinct from the skin mimicking layer 2.

The artificial blood vessels 4a, 4b, 4c enclose artificial blood, which may be any standard artificial blood known in the art. The artificial blood preferably reproduces the mechanical as well as the ultrasound properties of actual blood. However, this is less important for blood, as once the needle has entered the blood vessel the insertion has been completed; provided this does not have an influence on the mechanical properties of the blood vessel, the artificial blood could therefore not necessarily reproduces the mechanical properties of actual blood but only reproduces the ultrasound properties of actual blood.

The artificial blood vessels 4a, 4b, 4c may be connected to a pump for simulating blood flow. The blood flow may therefore be changed easily.

The phantom 1 of the invention is adjustable to simulate any human body site: the anatomic dimensions and the stiffness of the skin layer 2, the subcutaneous fat mimicking layer 3 and the artificial blood vessels 4a, 4b, 4c can be varied. The artificial blood vessels 4a, 4b, 4c may mimic veins or arteries. Other anatomical elements like bones may easily be incorporated into the phantom 1. The main parameters for adjusting the phantom 1 to a particular body site are the geometry, thickness and choice of the materials of the different elements of the phantom 1.

A process for making the phantom 1 of the invention will now be described in more details.

The skin layer 2 is formed in a mold, from fluid latex and with a thickness similar to that of human skin, for instance approximately 1.2 mm. Blood vessels also are formed; they are in the form of flexible tubular members, having a tubular wall made of fluid latex with a thickness that is about 10% of the inner vessel diameter. In order to get its final shape, fluid latex is shaped and then hardened.

A mold is provided for making the phantom 1, the dimension of which are 12*6*6 cm³. The mold comprises walls provided with holes, through which the artificial blood vessels are passed in order to position them in the volume of the mold (therefore in the volume of the phantom 1 where it is formed). For making the phantom of FIG. 1, the holes are provided on opposing walls of the mold. According to other embodiments, holes may be provided on consecutive side walls, with for instance turning blood vessels; any geometry may be contemplated.

The fat mimicking layer 3 is then prepared. In the following, the unit used for concentrations is % w/v, that is to say % weight/volume; 1% w/v means 1 g per 100 ml. The fat layer 3 is formed in a hydrogel, which is prepared by mixing agarose with 0.88% w/v of an aluminum oxide (Al₂O₃) powder with particles of a 0.3 μm diameter, 0.94% w/v of an Al₂O₃ powder with particles of a 3.0 μm diameter, 0.54% w/v of silicon carbide (SiC) (with for instance a 400 mesh grain size) and 0.43% of benzalkonium chloride (BC) (which is a viscous fluid), in pure water. The mixture is sealed and heated to 99° C. before slowly being cooled. The mixture is then poured into the mold containing the artificial blood vessels 4a, 4b, 4c so as to form the fat layer 3 around the artificial blood vessel 4a, 4b, 4c which are held in position between the holes of the walls of the mold. Once this pouring is terminated and the fat layer 3 formed, the already prepared skin layer 2 is deposited on top of the fat layer 3.

With such a fabrication process and such a choice in the composition of the materials, the phantom 1 reproduces the ultrasound and mechanical properties of a human body site when a needle in inserted therein.

If the fat mimicking layer 3 is relatively stiff, e.g. based on a 1.5% w/v agarose concentration, and artificial blood vessels of at least 4 mm diameter are embedded, the phantom 1 is mainly adapted for simulating the collapsibility of veins. Through lowering of the agarose concentration to 1.0% w/v and embedding small artificial blood vessels of approximately 2 mm in diameter, the phantom 1 is mainly adapted for simulating veins rolling away during the needle insertion.

The above concentrations of the various elements of the phantom 1 may be varied, in particular if the mimicked body site is different. According to an embodiment, for manufacturing reasons, the concentrations shall be subjected to the following restrictions:

the ratio between the 0.3 μm diameter Al₂O₃ particles and the 3.0 μm diameter Al₂O₃ particles may be constant whatever the mimicked human body site is, and substantially equal to 0.88/0.94, which permits to obtain good ultrasound properties;

similarly, the SiC concentration may be related to the Al₂O₃ concentration, for instance the ratio between the SiC concentration and the 3.0 μm diameter Al₂O₃ particles concentration may be substantially equal to 0.54/0.94;

the agarose concentration may be inferior to 1%, in order to get a stable hydrogel, but increase up to 2% for mimicking stiff human body sites;

the BC concentration may be inferior to 1%; in this case, the influence of BC on the mechanical properties of the phantom 1 may be considered as negligible; in case the BC concentration is superior to 1%, since BC is highly viscous, it might influence the mechanical properties of the phantom 1; in a general manner, BC protects the material against infection and does not need to be present with high concentration to be efficient.

The concentrations of agarose and Al₂O₃ influence the mechanical properties of the tissue layer: if one of those concentration increases, the stiffness of the phantom 1 also increases.

According to another embodiment of the invention, the hydrogel for mimicking the fat layer is an alginate based hydrogel.

The phantom 1 of the invention may be used for manual or automated needle insertion simulation. For manual insertion, a probe, held by the person practicing the insertion, is placed on the surface of the skin mimicking layer 2 of the phantom 1 of the invention; the probe is linked to a screen that permits to check the insertion of the needle in the phantom 1, for monitoring its insertion into a particular blood vessel 4a, 4b, 4c. For automated insertion, a device is used, which comprises driving means for inserting the needle, ultrasound imaging means and image processing means. The image processing means analyze the images of the needle in the skin taken by the ultrasound imaging means, the obtained information on the position of the needle being used for automatically driving the needle.

The ultrasound properties of the phantom 1 of the invention may also be useful for performing Doppler mode ultrasound monitoring. The Doppler mode permits to get information on the blood flow.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Phantom for simulating the ultrasound guided insertion of a needle in a blood vessel of a human body site, the phantom comprising:
a skin mimicking layer (2), formed in a first material;
a tissue mimicking layer (3), formed in a second material and
at least one artificial blood vessel (4a, 4b, 4c), formed in a third material,
the first, second and third material being arranged to reproduce both the mechanical and the ultrasound properties of the corresponding parts of the human body site.

2. Phantom according to claim 1, wherein the artificial blood vessel (4a, 4b, 4c) comprises a tubular wall which is formed in the third material.

3. Phantom according to claim 1, wherein the second and third materials are different.

4. Phantom according to claim 1, wherein the first and third materials are similar or identical.

5. Phantom according to claim 4, wherein the first and third materials are latex, in particular fluid latex.

6. Phantom according to claim 1, wherein the second material is an aqueous gel, in particular a gel substantially comprising between 1% w/v and 1.5% w/v of agarose, with 0.88% w/v of an Al₂O₃ powder with particles of a 0.3 μm diameter, 0.94% w/v of an Al₂O₃ powder with particles of a 3.0 μm diameter, 0.54% w/v of SiC and 0.43% of BC, in pure water.

7. Phantom according to claim 1, wherein the second material is an alginate based hydrogel.

8. Process for making the phantom of claim 1, comprising:
preparing a skin mimicking layer (2),
preparing a mixture for forming a tissue mimicking layer (3),
preparing at least one artificial blood vessel (4a, 4b, 4c),
disposing the artificial blood vessel (4a, 4b, 4c) in a mold comprising means for holding the artificial blood vessel (4a, 4b, 4c),
pouring the mixture around the artificial blood vessel (4a, 4b, 4c) for forming the tissue mimicking layer (3) and
depositing the skin mimicking layer (2) on the tissue mimicking layer (3).
